(19) United States
(12) Patent Application Publication
(10) Pub. No.: US 2025/0128496 A1
(43) Pub. Date: Apr. 24, 2025

(54) MULTI-LAYERED SKATES

(71) Applicant: PUFENG NEW TECHNOLOGY MATERIALS CO., LTD., TAICHUNG CITY (TW)

(72) Inventor: Shui-Yuan MA, TAICHUNG CITY (TW)

(21) Appl. No.: 18/522,359

(22) Filed: Nov. 29, 2023

(30) Foreign Application Priority Data
Oct. 19, 2023 (TW) 112211269

(51) Int. Cl. B32B 5/26; A43B 5/16; B32B 5/02; B32B 5/06; B32B 7/12; B32B 27/12; B32B 27/32

(52) U.S. Cl. CPC B32B 5/265; A43B 5/1666; B32B 5/022; B32B 5/073; B32B 7/12; B32B 27/12; B32B 27/32; B32B 2262/0253; B32B 2307/7376; B32B 2437/02

(57) ABSTRACT

A multi-layered skate has a base layer, two fabric layers which are disposed at two sides of the base layer respectively, and a non-woven layer arranged next to one of the fabric layers, at least one fiber of the non-woven layer is intertwined with at least one fiber of the fabric layers.

### FIELD OF INVENTION

The present invention relates to a structure and materials of a skate, especially to a multi-layered skate.

### BACKGROUND OF THE INVENTION

In order to improve a strength of a skate, a strength material is usually added into a common skate which is made of leather (natural leather or artificial leather). Although leather can show strong toughness and not breakable, the leather often causes discomfort or even sprains to the user's feet because it is not soft enough. The reinforcing material can achieve the anti-collision function, but it also increases the weight of the skate, which affects the fit between the skate and the foot, and destroy the comfort when wearing. Thus, it is urge to develop a skate which is comfortable, lightweight, high-hardness and high-strength in the related field.

### SUMMARY OF THE INVENTION

In order to overcome the problems of a common skate mentioned above, the present invention provides a multi-layered skate comprising a base layer, two fabric layers which are disposed at two sides of the base layer respectively, and a non-woven layer arranged next to one of the fabric layers, at least one fiber of the non-woven layer is intertwined with at least one fiber of the fabric layers.

The advantage of the multi-layered skate is that the body is composed of the base layer and two fabric layers, can enhance a structural strength, exhibits support likes a board material, and impact resistance like a fabric which has the advantages of high impact resistance, and non-breakable after being impacted in a low temperature environment.

Wherein, the adhesive film can act as a strength material as the characteristics of high toughness and high impact strength and make the body can also exhibit low water absorption characteristics, and allowing the skate to escape the shortcomings of traditional heavy leather.

Wherein, the non-woven layer is disposed toward the inside of the body to make the body can exhibit filling properties, fit with the foot, and increasing the comfort of the shoe body when wear.

Worthily to note is that when the lining layer is disposed on the surface of the non-woven layer, the non-woven layer strength the adhesion with the lining layer through its rough surface.

In addition, the non-woven layer and the lining layer can be made with a high melting point materials relatively to the base layer, adhesive film, and fabric layers. Therefore, the non-woven fabric and the lining layer can retain the complete structural when laminated and hot-pressed to bonded at mean time with other layers.

### BRIEF DESCRIPTION OF THE DRAWINGS

FIG. 1 is a perspective view of a multi-layered skate in accordance with the present invention;

FIG. 2 is an enlarged partial cross sectional perspective view of the multi-layered skate in FIG. 1;

FIG. 3 is a cross sectional side view of a first preferred embodiment of a multi-layered skate in accordance with the present invention; and

FIG. 4 is a cross sectional view of a second preferred embodiment of a multi-layered skate in accordance with the present invention; and.

### DETAILED DESCRIPTION OF THE PREFERRED EMBODIMENTS

In order to make purposes, technical solutions, and advantages of the present invention to be clearer, the following content provides some preferred embodiments in accordance with the present invention.

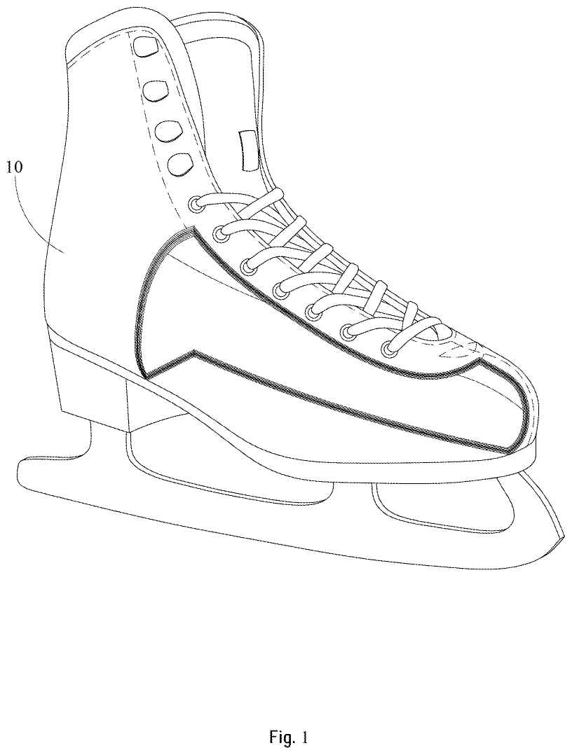

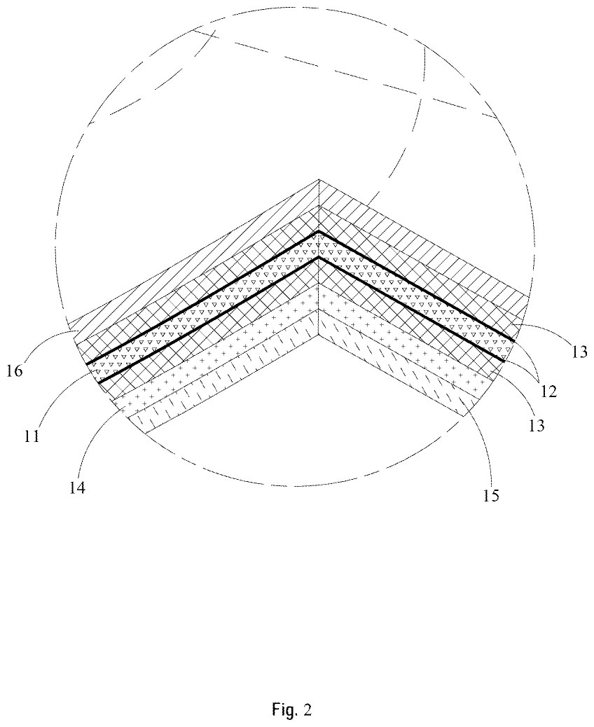

With reference to FIG. 1 and FIG. 2, a multi-layered skate in accordance with the present invention comprises a body 10 which is multi-layered and comprises a base layer 11, two fabric layers 13 which are disposed at two sides of the base layer 11 respectively and a non-woven layer 14 which is arranged next to one of the fabric layers 13. The body which is composed of the base layer 11 and two fabric layers 13 can enhance a structural strength and exhibits support likes a board material and impact resistance like a fabric.

Wherein, at least one fiber of the non-woven layer 14 is intertwined with at least one fiber of the fabric layers 13. In the preferred embodiment, at least one part of the non-woven layer 14 and at least one part of the fabric layer 13 are intertwined and fixed to each other by needling.

The material of the base layer 11 and/or the fabric layers 13 are not limited. In some embodiments, the material of the base layer 11 and/or the fabric layers 13 can be a thermoplastic, comprising polypropylene (PP), Nylon, polyurethane (PU), thermoplastic urethane (TPU) or polyethylene terephthalate (PET) to present characteristics of high elasticity, high shape retention for increasing durability and strength of the body 10.

In some embodiments, the material of the fabric layer 13 may also include a natural fiber comprising linen, jute, cotton.

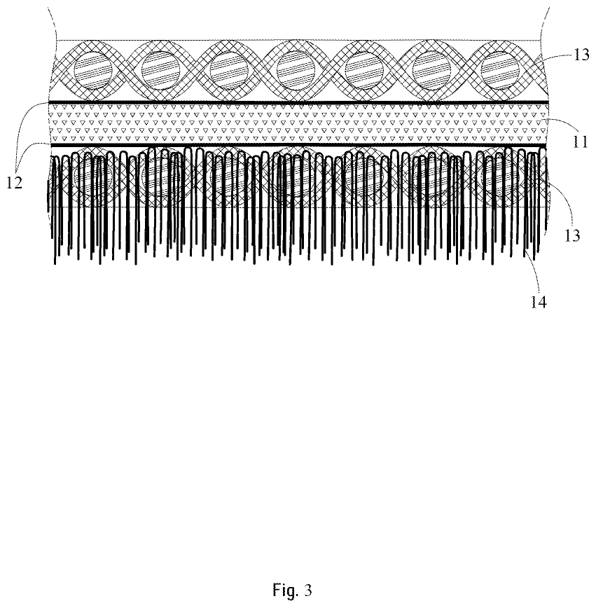

Referring to FIG. 2 and FIG. 3, the fabric layer 13 is woven-like which has the advantages of high impact resistance, and non-breakability after being impacted in a low temperature environment.

In certain embodiment, the base layer 11 and the two fabric layers 13 also can be bonded to each other by gluing. Preferably, the base layer 11 and the two fabric layers 13 can be made by a same material that can be laminated after heating and pressing.

In the preferred embodiment, two adhesive films 12 are respectively disposed between the base layer 11 and the two fabric layers 13 to adhere them to each other. Each adhesive film 12 can be made of a material which is similar as the base layer 11 and/or the fabric layers 13. For example, when the base layer 11 is made of polypropylene (PP) plastic plate and the fabric layers 13 are made of polypropylene (PP) fiber, the adhesive film 12 can be made of modified polyolefin film or modified polyester film, which can also act as a strength material as the characteristics of high toughness and high impact strength to make the body 10 be lightweight.

Worthily to notice is that, the structure provided in this embodiment, the adhesive film 12 is covered by the fabric layer 13, which can eliminate the discomfort problem caused by previous strength materials in a common skate.

In some embodiments, more than one fabric layers 13 are disposed at one side of the base layer 11, and a respective adhesive film 12 is placed between each adjacent two fabric layers 13. With the adhesive film 12, in addition to the advantages of strength and lightweight, the body 10 can also exhibit low water absorption characteristics, and allowing the skate to escape the shortcomings of traditional heavy leather.

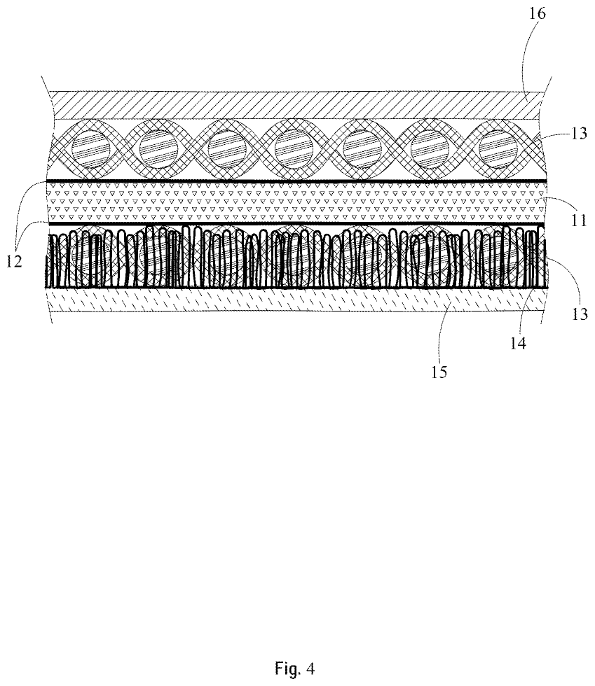

With reference to FIGS. 3 and 4, the non-woven layer 14 can be made of materials such as manufactured fiber, synthetic fiber, natural fiber or any fiber which may maintain flexibility and thermal insulation effects. The non-woven layer 14 is disposed toward the inside of the body 10 to make the body 10 can exhibit filling properties, fitting with the foot, and increasing the comfort of the shoe body 10 when wear.

Moreover, the body 10 can add a functional layer according to the needs. For example, the functional layer is a lining layer 15 disposed on the surface of the non-woven layer 14.

Worthily to note is that when the lining layer 15 is disposed on the surface of the non-woven layer 14, the non-woven layer 14 strengthen the adhesion with the lining layer 15 through its rough surface.

In addition, the non-woven layer 14 and the lining layer 15 can be made of a high melting point materials relatively to the base layer 11, adhesive film 12, and fabric layers 13. Therefore. the non-woven fabric 14 and the lining layer 15 can retain the complete structural when laminated and hot-pressed to be bonded at mean time with other layers (base layer 11, adhesive film 12, and fabric layers 13).

In certain embodiment, the functional layer is a thermoplastic film 16 which is attached on the surface of the fabric layer 13 at the opposite side of non-woven layer 14, and the thermoplastic film 16 may enhance the impact resistance of the shoe body 10. The material of the thermoplastic film 16 can be selected including thermoplastic elastomer (TPE), polypropylene (PP), nylon, poly(ethylene terephthalateco-1,4-cylclohexylenedimethylene terephthalate) (PETG), poly(1,4-cyclohexylene dimethylene terephthalate glycol) (PCTG) or polyethylene terephthalate (PET).

Said TPE also can be selected including thermoplastic polyolefin (TPO), thermoplastic polyurethane (TPU) and thermoplastic polyamide elastomer (TPAE).

Wherein, a thickness of the base layer 11 is between 0.3-4.0 mm, the thickness of the adhesive film 12 is between 0.05-0.15 mm, the thickness of each fabric layer 13 is between 0.05-0.35 mm, the thickness of the non-woven layer 14 is between 0.1-0.3 mm, the thickness of the lining layer 15 is between 0.1-0.3 mm, and the thickness of the thermoplastic film 16 is between 0.05-0.4 mm.

A manufacturing method of the multi-layered skate in each embodiment mentioned above has steps comprising: stacking all the layers sequentially, setting a hot-pressing parameter according to the material and thickness of each layer, sending all the layers in a stacked-like to hot press, and holding in a duration between 5-15 minutes to form the body 10.

Wherein, when the functional layer is the thermoplastic film 16, the thermoplastic film 16 can be coated on the surface of the fabric layers 13 after hot press.

Wherein, the hot-pressing parameter comprises a pressing temperature is between 150-175° C., a pressure is between 10˜30 kg/cm².

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A multi-layered skate comprising:
a base layer;
two fabric layers which are disposed at two sides of the base layer respectively; and
a non-woven layer arranged next to one of the fabric layers, at least one fiber of the non-woven layer is intertwined with at least one fiber of the fabric layer being next to the non-woven layer.

2. The multi-layered skate as claimed in claim 1, at least one part of the non-woven layer and at least one part of the fabric layer being next to the non-woven layer are intertwined to each other by needling.

3. The multi-layered skate as claimed in claim 1, wherein the material of the base layer and/or the fabric layers is a thermoplastic selected from the group consisting of polypropylene (PP), Nylon, polyurethane (PU), thermoplastic Urethane (TPU) or polyethylene terephthalate (PET).

4. The multi-layered skate as claimed in claim 3, wherein the base layer and the two fabric layers are made by a same material.

5. The multi-layered skate as claimed in claim 3, two adhesive films are respectively disposed between the base layer and the two fabric layers to adhere the base layer and the two fabric layers, and each adhesive film is covered by a corresponding one of the fabric layers.

6. The multi-layered skate as claimed in claim 5, wherein a thickness of the base layer is between 0.3-4.0 mm, a thickness of the adhesive film is between 0.05-0.15 mm, a thickness of each fabric layer is between 0.05-0.35 mm, and a thickness of the non-woven layer is between 0.1-0.3 mm.

7. The multi-layered skate as claimed in claim 5, each adhesive film is modified polyolefin film or modified polyester film.

8. The multi-layered skate as claimed in claim 6, more than one fabric layers are disposed at one side of the base layer, and more than one adhesive film are placed between each adjacent two fabric layers.

9. The multi-layered skate as claimed in claim 6, a lining layer disposed on a surface of the non-woven layer, the non-woven layer and the lining layer has a higher melting point then that of the base layer, adhesive film, and fabric layers.

10. The multi-layered skate as claimed in claim 6, a thermoplastic film attached on a surface of one of the fabric layers which is opposite to the non-woven layer.

11. The multi-layered skate as claimed in claim 9, a thermoplastic film attached on a surface of one of the fabric layers which is opposite to the non-woven layer.

12. The multi-layered skate as claimed in claim 11, wherein, the thickness of the lining layer is between 0.1-0.3 mm, and the thickness of the thermoplastic film is between 0.05-0.4 mm.

13. The multi-layered skate as claimed in claim 12, wherein the non-woven layer is manufactured fiber, synthetic fiber or natural fiber.

14. The multi-layered skate as claimed in claim 13, wherein the thermoplastic film is selected from the group consisting of thermoplastic elastomer (TPE), polypropylene (PP), nylon, poly(ethylene terephthalateco-1,4-cylclohexylenedimethylene terephthalate) (PETG), poly(1,4-cyclohexylene dimethylene terephthalate glycol) (PCTG) and polyethylene terephthalate (PET).

15. The multi-layered skate as claimed in claim 3, wherein the base layer and the two fabric layers are bonded to each other by gluing.
